(19) United States
(12) Patent Application Publication
(10) Pub. No.: US 2021/0246065 A1
(43) Pub. Date: Aug. 12, 2021

(54) METHOD FOR PRODUCING GLASS PARTICULATE DEPOSIT

(71) Applicant: SUMITOMO ELECTRIC INDUSTRIES, LTD., Osaka-shi, Osaka (JP)

(72) Inventors: Masatoshi HAYAKAWA, Osaka-shi, Osaka (JP); Masumi ITO, Osaka-shi, Osaka (JP); Tomomi MORIYA, Osaka-shi, Osaka (JP)

(73) Assignee: SUMITOMO ELECTRIC INDUSTRIES, LTD., Osaka-shi, Osaka (JP)

(21) Appl. No.: 16/973,146

(22) PCT Filed: Jun. 13, 2019
(86) PCT No.: PCT/JP2019/023554

§ 371 Date: Dec. 8, 2020

(30) Foreign Application Priority Data
Jun. 15, 2018 (JP) 2018-114363

(51) Int. Cl. C03B 37/018

(52) U.S. Cl. CPC C03B 37/018; C03B 2207/36

(57) ABSTRACT

A method for producing a glass particulate deposit, said method comprising using siloxane as a raw material for glass, discharging the siloxane gasified in a vaporizer and a combustion gas from a burner and combusting, and thus forming a glass particulate deposit in a reaction vessel, wherein: after producing a good section of the glass particulate deposit, the supply of the siloxane that is the raw material for glass to the burner is ceased while continuously supplying the combustion gas to the burner; then the glass particulate deposit is taken out from the reaction vessel; a raw material gas port from the vaporizer to the burner is purged by flowing an inert gas therethrough; and, when a color derived from the combustion of the siloxane gas is not observed any more in the flame of the burner, then the supply of the combustion gas is ceased.

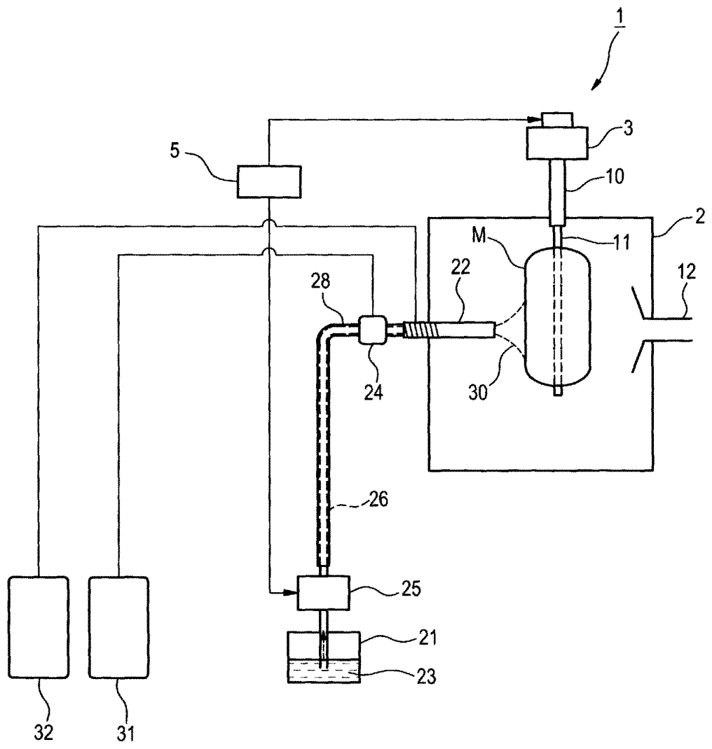

### TECHNICAL FIELD

The present disclosure relates to a method for producing a glass particulate deposit. The application claims priority based on Japanese Patent Application No. 2018-114363 filed on Jun. 15, 2018, the contents of which are incorporated herein by reference in its entirety.

### BACKGROUND ART

Patent Literature 1 discloses a method for producing a glass particulate deposit by using siloxane as a raw material for glass synthesis.

Patent Literature 2 discloses that, upon changing to a mode in which fine glass particles are not deposited, flaming gas is flowed to a seal gas discharge nozzle instead of the seal gas, and the flaming gas in the combustion gas port at the combustion gas port is replaced with the purge gas.

Patent Literature 3 discloses that the raw material gas and the inert gas A are switched upstream of a mass flow controller (MFC) at the time when the supply of the raw material gas for glass to the burner is made zero, and the gas from the MFC is switched from the burner side to the discharge side, the inert gas B is supplied to the burner, and the raw material gas supply path is purged with the inert gases A and B.

### CITATION LIST

### Patent Literature

Patent Literature 1: JP2015-113259

Patent Literature 2: JP2012-232875

Patent Literature 3: JP2003-212554

### SUMMARY OF INVENTION

The method for producing a glass particulate deposit according to the present disclosure is

a method for producing a glass particulate deposit, in which the method uses siloxane as a raw material for glass and includes discharging the siloxane gasified in a vaporizer and a combustion gas from a burner for combustion and thus forming a glass particulate deposit in a reaction vessel, in which the method includes:

after a good product portion of the glass particulate deposit is produced, stopping the supply of the siloxane as the raw material for glass to the burner while continuously supplying the combustion gas to the burner;

removing the glass particulate deposit from the reaction vessel;

purging a raw material gas port spanning from the vaporizer to the burner by flowing an inert gas therethrough; and

when a color derived from the combustion of the siloxane gas is not observed any more in the flame of the burner, stopping the supply of the combustion gas.

The method for producing a glass particulate deposit according to the present disclosure is

a method for producing a glass particulate deposit, in which the method uses siloxane as a raw material for glass and includes discharging the siloxane gasified in a vaporizer and a combustion gas from a burner for combustion and thus forming a glass particulate deposit in a reaction vessel, in which the method includes:

after a good product portion of the glass particulate deposit is produced, stopping the supply of the siloxane as the raw material for glass to the burner while continuously supplying the combustion gas to the burner;

purging a raw material gas port spanning from the vaporizer to the burner by flowing an inert gas therethrough; and

heating the glass particulate deposit with the flame formed by the combustion gas for a certain period of time while traversing the glass particulate deposit relative to the burner, and then stopping the supply of the combustion gas.

### BRIEF DESCRIPTION OF DRAWINGS

FIGURE is a configuration diagram showing an embodiment of an apparatus for producing a glass particulate deposit according to an aspect of the present disclosure.

### DESCRIPTION OF EMBODIMENTS

### Problem to be Solved by the Present Disclosure

In the case of producing a glass particulate deposit by the method described in Patent Literature 1, liquid siloxane is gasified by a vaporizer and discharged from a burner, and glass particles are formed and deposited by an oxidation reaction. After a good product portion of the glass particulate deposit is produced, the supply of siloxane gas to the burner is stopped, the glass particulate deposit is removed from the reaction vessel of the producing apparatus, another target member (raw rod) is newly mounted in the reaction vessel, and a new glass particulate deposit is produced.

In the above case, from the stopping of the supply of the siloxane gas to the burner until the production of a new glass particulate deposit, siloxane may remain between the vaporizer and a gas discharge port of the burner. The remaining siloxane reacts with oxygen flowing back from the gas discharge port between the positions described above to form incompletely oxidized silicon oxide (SiO_{X} (X<2)) particles, and ring-opened siloxanes are polymerized with each other to form a gel-like material. The above silicon oxide (SiO_{X} (X<2)) particles and gel-like material may block the space between the vaporizer and the gas discharge port of the burner, or may be mixed in the newly produced glass particulate deposition layer, which results in defective products.

Therefore, it is an object of the present disclosure to provide a method for producing a high-quality glass particulate deposit when siloxane is used as a raw material for glass synthesis.

### Effect of the Present Disclosure

According to the present disclosure, when siloxane is used as a raw material for glass synthesis, it is possible to produce a high-quality glass particulate deposit.

### Description of Embodiments of the Present Disclosure

First, the contents of the embodiments of the present disclosure will be listed and described.

A method for producing a glass particulate deposit according to one aspect of the present disclosure is

(1) a method for producing a glass particulate deposit, in which the method uses siloxane as a raw material for glass and includes discharging the siloxane gasified in a vaporizer and a combustion gas from a burner for combustion and thus forming a glass particulate deposit in a reaction vessel, in which the method includes:

after a good product portion of the glass particulate deposit is produced, stopping the supply of the siloxane as the raw material for glass to the burner while continuously supplying the combustion gas to the burner;

removing the glass particulate deposit from the reaction vessel;

purging a raw material gas port spanning from the vaporizer to the burner by flowing an inert gas therethrough; and

when a color derived from the combustion of the siloxane gas is not observed any more in the flame of the burner, stopping the supply of the combustion gas.

With this configuration, it is possible to prevent the gaseous siloxane from remaining in the raw material gas port from the vaporizer to the burner after the supply of siloxane is stopped. As a result, a high-quality glass particulate deposit can be produced.

A method for producing a glass particulate deposit according to one aspect of the present disclosure is

(2) a method for producing a glass particulate deposit, in which the method uses siloxane as a raw material for glass and includes discharging the siloxane gasified in a vaporizer and a combustion gas from a burner for combustion and thus forming a glass particulate deposit in a reaction vessel, in which the method includes:

after a good product portion of the glass particulate deposit is produced, stopping the supply of the siloxane as the raw material for glass to the burner while continuously supplying the combustion gas to the burner;

purging a raw material gas port spanning from the vaporizer to the burner by flowing an inert gas therethrough; and

heating the glass particulate deposit with the flame formed by the combustion gas for a certain period of time while traversing the glass particulate deposit relative to the burner, and then stopping the supply of the combustion gas.

With this configuration, it is possible to prevent the gaseous siloxane from remaining in the raw material gas port from the vaporizer to the burner after the supply of siloxane is stopped. As a result, a high-quality glass particulate deposit can be produced.

With the method for producing a glass particulate deposit according to (1) or (2) described above,

(3) even after the production of the glass particulate deposit, it is preferable to continuously purge the raw material gas port spanning from the vaporizer to the burner until the production of a next glass particulate deposit is newly started.

With this configuration, from the stopping of the supply of the siloxane gas until the production of a new glass particulate deposit, it is possible to prevent, from the gas discharge port of the burner to the raw material gas port, the mixing of the oxygen due to the backflowing, and prevent the formation of incompletely oxidized silicon oxide (SiO_{X} (X<2)) particles or polymerization of ring-opened siloxanes with each other that results in a gel-like material.

With the method for producing a glass particulate deposit according to (1) or (2) described above,

(4) when a good product portion of the glass particulate deposit is produced, it is preferable to, using a carrier gas that is an inert gas to gasify the siloxane in the vaporizer, perform purging of the raw material gas port by continuously flowing the carrier gas even after the supply of the siloxane gas to the burner is stopped.

With this configuration, it is not necessary to further provide a mechanism for supplying the inert gas that is used for purging, and the carrier gas supply mechanism already provided can be used as it is, so that the apparatus configuration can be simplified.

With the method for producing a glass particulate deposit according to any one of (1) to (4) described above,

(5) it is preferable to use nitrogen as the inert gas.

With this configuration, by using inexpensive nitrogen as the inert gas, it is possible to produce the glass particulate deposit at low cost.

With the method for producing a glass particulate deposit according to any one of (1) to (5) described above,

(6) it is preferable that a pipe between the vaporizer and the burner is formed of a material containing a metal.

When a pipe of a material containing a metal is provided between the vaporizer and the burner, the oxidization and gelation of the gaseous siloxane remaining in the pipe would be more likely to occur, but in the present embodiment, the problem can be effectively prevented even when an apparatus uses a pipe of a material containing a metal that easily causes such a problem. When the pipe is formed of a material containing a metal, it may be heated to a high temperature.

With the method for producing a glass particulate deposit according to any one of (1) to (6) described above,

(7) it is preferable to heat the pipe between the vaporizer and the burner to a temperature equal to or higher than the boiling point of siloxane.

With this configuration, it is possible to prevent the remaining siloxane gas from cooling and liquefying.

### Details of Embodiments of the Present Disclosure

### Outline of Producing Method and Equipment Used, Etc.

Hereinafter, an example of an embodiment of a method for producing a glass particulate deposit according to an embodiment of the present disclosure will be described with reference to the accompanying drawing.

FIGURE is a configuration diagram of an apparatus 1 for producing a glass particulate deposit according to the present embodiment (hereinafter, also referred to as “glass particulate deposit producing apparatus” or “deposit producing apparatus”). The deposit producing apparatus 1 includes a reaction vessel 2, a lifting and rotating device 3, a siloxane supply tank 21, a carrier gas supply device 31, a combustion gas supply device 32, a burner 22 for producing glass particles, and a control unit 5 that controls the operation of each unit.

The reaction vessel 2 is a container in which a glass particulate deposit M is formed, and includes a discharge pipe 12 attached to a side surface of the container.

The lifting and rotating device 3 is a device for moving up and down and rotating the glass particulate deposit M with a support rod 10 and a raw rod 11. The lifting and rotating device 3 raises and lowers and rotates the glass particulate deposit M based on a control signal transmitted from the control unit 5.

The support rod 10 is disposed by being inserted through a through hole formed in an upper wall of the reaction vessel 2, and to one end (lower end in FIGURE) thereof that is disposed in the reaction vessel 2, the raw rod 11 is attached. The other end (upper end in FIGURE) of the support rod 10 is held by the lifting and rotating device 3.

The raw rod 11 is a rod on which glass particles 30 are deposited, and is attached to the support rod 10.

The discharge pipe 12 is a pipe for discharging the glass particles 30, which are not attached to the raw rod 11 and the glass particulate deposit M, to the outside of the reaction vessel 2.

Siloxane gas, seal gas (not shown), and combustion gas are supplied to the burner 22.

The siloxane gas is obtained by mixing a liquid siloxane 23 sent from the siloxane supply tank 21 through a mass flow controller (MFC) 25 with the carrier gas in the vaporizer 24. Specifically, in the vaporizer 24, the siloxane gas is generated by dropping the liquid siloxane 23 onto the carrier gas injected at high speed. The carrier gas is supplied from the carrier gas supply device 31 to the vaporizer 24.

The combustion gas is supplied from the combustion gas supply device 32 to the burner 22.

The MFC 25 is a device that controls a supply rate of the liquid siloxane 23 to be sent from the siloxane supply tank 21 and supplies the liquid siloxane 23 to the vaporizer 24 via the supply pipe 26. The MFC 25 controls the supply rate of the liquid siloxane 23 to be supplied to the vaporizer 24 based on the control signal transmitted from the control unit 5. The liquid siloxane 23 is supplied from the siloxane supply tank 21 to the MFC 25 by pumping with inert gas, or by pump. Helium is preferably used as the inert gas for the pumping. Since the helium hardly dissolves in the liquid siloxane, it is possible to prevent a variation error in the supply rate due to vaporization of the dissolved gas component (generation of bubbles).

The supply pipe 26 is a pipe that guides the liquid siloxane 23 at a supply rate controlled by the MFC 25 to the vaporizer 24. The supply pipe 26 preferably has a function of heating the liquid siloxane 23 so that the liquid siloxane 23 is easily vaporized in the vaporizer 24. The function of heating the liquid siloxane 23 in the supply pipe 26 may be provided by winding a tape heater 28, which is a heating element, around an outer periphery of the supply pipe 26, for example. The tape heater 28 is energized to heat the supply pipe 26 so that the temperature of the liquid siloxane 23 to be supplied to the vaporizer 24 can be brought close to a temperature suitable for vaporization in advance. For example, when the liquid siloxane 23 is octamethylcyclotetrasiloxane (OMCTS), it is preferable to increase the temperature to 150 to 170° C., which is slightly lower than the standard boiling point of 175° C. of the OMCTS.

The burner 22 oxidizes the siloxane gas obtained in the vaporizer 24 in a flame to generate the glass particles 30, and the generated the glass particles 30 are sprayed onto the raw rod 11 to be deposited.

Siloxane exists in a gaseous state between the vaporizer 24 and the burner 22, but at this time, it is preferable to provide a function of heating a path between the vaporizer 24 and the burner 22 so that the siloxane gas is kept from being cooled and liquefied. That is, like the supply pipe 26, it is preferable to wind a tape heater 28, which is a heating element, around the outer periphery of the pipe between the vaporizer 24 and the burner 22 and also a part of the outer periphery of the burner 22. When the tape heater 28 is energized, the pipe between the vaporizer 24 and the burner 22, and the burner 22 are heated, which may prevent liquefaction of the siloxane gas. For example, when the liquid siloxane 23 is OMCTS, the temperature may be increased to a temperature of 175 to 200° C. which is higher than the standard boiling point of OMCTS of 175° C.

For the burner 22 for ejecting the siloxane gas or the combustion gas, a cylindrical multi-nozzle (emission port) structure or a linear multi-nozzle structure is used, for example.

The control unit 5 controls each operation of the lifting and rotating device 3, the MFC 25, and the like. The control unit 5 transmits, to the lifting and rotating device 3, a control signal for controlling the raising and lowering speed, and the rotating speed of the glass particulate deposit M. The control unit 5 transmits, to the MFC 25, a control signal for controlling the supply rate of the liquid siloxane 23 to be supplied to the vaporizer 24.

### Deposition Process

Glass particles are deposited by an outside vapor deposition (OVD) method to produce the glass particulate deposit M. First, as shown in FIGURE, with the support rod 10 attached to the lifting and rotating device 3, and the raw rod 11 attached to the lower end of the support rod 10, part of the raw rod 11 and the support rod 10 is placed in the reaction vessel 2.

Then, the MFC 25 supplies the liquid siloxane 23, which is a raw material, to the vaporizer 24 while controlling the supply rate based on the control signal transmitted from the control unit 5.

The glass particles 30 are generated by oxidizing the siloxane gas in the combustion gas flame.

Then, the burner 22 continuously deposits the glass particles 30 generated in the flame onto the raw rod 11 that is rotated and raised and lowered.

The lifting and rotating device 3 raises and lowers and rotates the raw rod 11 and the glass particulate deposit M deposited on the raw rod 11 based on the control signal transmitted from the control unit 5.

The siloxane used as the raw material for glass in the present embodiment is not particularly limited, but a cyclic one is preferable, and among them, OMCTS is more preferable, because it is easily industrially available and can be easily stored and handled.

The carrier gas and the seal gas used in the present embodiment are not particularly limited as long as they are inert gases, but examples include helium gas, argon gas, nitrogen gas and the like, and the nitrogen gas is preferable considering it is inexpensive.

The combustion gas used in the present embodiment is not particularly limited as long as it is capable of flame formation and contains oxygen for oxidizing siloxane, but oxyhydrogen gas is preferable. The oxyhydrogen gas is a mixture of hydrogen (combustible gas) and oxygen (flammable gas). When hydrogen and oxygen are separately supplied to the burner 22, both hydrogen and oxygen are included in the combustion gas of the present disclosure.

Although the deposition process described above has been described by taking the outside vapor deposition (OVD) method as an example, the present disclosure is not limited to the OVD method. Like the OVD method, the present disclosure can be applied to a method of depositing glass from a raw material for glass by utilizing oxidation reaction, such as a vapor-phase axial deposition (VAD) method, a multiburner multilayer deposition (MMD) method, or the like, for example.

### Process After Completion of Deposition Process

After a good product portion of the glass particulate deposit M is produced in the deposition process described above, the supply of the siloxane gas to the burner 22 is stopped, and the glass particulate deposit M is removed from the reaction vessel 2 of the deposit producing apparatus 1. Then, another target member (raw rod 11) is newly mounted in the reaction vessel 2 to produce a new glass particulate deposit M.

However, as described above, when the siloxane gas remains in the raw material gas port, it may cause deterioration of the product.

Therefore, in the present embodiment, the siloxane gas is prevented from remaining in the raw material gas port spanning from the vaporizer 24 to the burner 22.

In the specification, the good product portion is a portion of the glass particulate deposit that can be used as a product such as an optical fiber.

Specifically, the processes of the following procedure are performed.

A1) After a good product portion of the glass particulate deposit M is produced, the supply of the siloxane as the raw material for glass to the burner 22 is stopped while the combustion gas is continuously supplied to the burner 22.

A2) The glass particulate deposit M is removed from the reaction vessel 2.

A3) A raw material gas port spanning from the vaporizer 24 to the burner 22 is purged by flowing an inert gas therethrough.

A4) When a color derived from the combustion of the siloxane gas is not observed any more in the flame of the burner 22, the supply of the combustion gas is stopped.

In the process A1) described above, the method of stopping the supply of the siloxane to the burner 22 may be either stopping the supply of the liquid siloxane from the MFC 25 to the vaporizer 24, or stopping the supply of the liquid siloxane from the siloxane supply tank 21 to the MFC 25. However, it is preferable to stop the supply of the liquid siloxane from the siloxane supply tank 21 to the MFC 25.

In the process A1) described above, the supply of the combustion gas to the burner 22 is continued even after the good product portion of the glass particulate deposit M is produced.

In the process A2) described above, the glass particulate deposit M is removed from the reaction vessel 2, but even at this time, the combustion gas is continuously supplied to the burner 22. Here, even when the supply of the siloxane to the burner 22 is stopped in the process A1) described above, since there is a remainder of siloxane, the siloxane is discharged from the burner 22.

The specific method of purging by flowing an inert gas in the process A3) is not particularly limited, but it is preferable to continue the supply of the carrier gas (inert gas) from the carrier gas supply device 31 to the vaporizer 24. Accordingly, it is not necessary to further provide a mechanism for supplying the inert gas that is used for purging, and the carrier gas supply mechanism already provided can be used as it is, so that the apparatus configuration can be simplified.

In the process A4) described above, the presence or absence of a color in the flame from the burner 22, which is derived from the combustion of the siloxane gas, is checked. When the siloxane burns, the flame appears white or orange. On the other hand, when oxyhydrogen gas is used as the combustion gas and only the oxyhydrogen gas is burning, the flame appears light blue. Therefore, when the flame from the burner 22 does not appear white or orange, but appears light blue only, it may be determined that there is no siloxane gas remaining in the pipe. After that, the supply of combustion gas is stopped.

Even after the production of the glass particulate deposit M, it is preferable to continuously purge the raw material gas port spanning from the vaporizer 24 to the burner 22 until the production of the next glass particulate deposit M is newly started. Accordingly, from the stopping of the supply of siloxane until the production of a new glass particulate deposit, it is possible to prevent, from the gas discharge port of the burner 22 to the raw material gas port, the oxygen from flowing back.

In the apparatus used in the present embodiment, the pipe between the vaporizer 24 and the burner 22 may be formed of a material containing a metal. Generally, when the siloxane is in an environment of contact with a metal, oxidation and gelation easily occur due to the catalytic action of the metal. However, in the present embodiment, since siloxane is effectively discharged from the pipe between the vaporizer and the burner, the disadvantage mentioned above does not occur even when the pipe is formed of a material containing a metal. When the pipe is formed of a material containing a metal, it may be heated to a high temperature.

In the apparatus used in the present embodiment, the burner 22 may be a mechanism that is retreated in a radial direction of the glass particulate deposit M according to the growth of the glass particulate deposit M. At least a part of the supply pipe 26 between the vaporizer 24 and the MFC 25 may be formed of a flexible material such as fluororesin.

After that, the glass particulate deposit M manufactured in the present embodiment is dehydrated and sintered to make the glass transparent, and the glass base material is obtained. The obtained glass base material achieves high-quality such as very few bubbles.

### Modification of Process After Completion of Deposition Process

The process after the completion of the deposition process is not limited to the process (hereinafter, also referred to as “process A”) that includes the processes A1) to A4) described above. In the following description, process B, which is a modification of the process A and which may be performed instead of process A, will be described.

In the process A, after the good product portion of the glass particulate deposit M is manufactured in the deposition process, the supply of siloxane gas to the burner 22 is stopped, and the glass particulate deposit M is removed from the reaction vessel 2 of the deposit producing apparatus 1, and although the combustion gas could be flowed and burned until the siloxane remaining in the raw material gas port is completely discharged, the timing of removing the glass particulate deposit M from the reaction vessel 2 is not particularly limited. The process B is a process that is continued without removing the glass particulate deposit M from the reaction vessel 2 until the supply of the combustion gas to the burner 22 is stopped. However, if the siloxane gas remains in the raw material gas port, since a gel-like material adheres to the produced glass particulate deposit M and causes deterioration of the product, in the process B, the combustion gas is allowed to flow for a certain period of time even after the remaining siloxane is completely discharged, so that the surface of the deposited glass particulate deposit is roasted.

In the process B, specifically, the processes of the following procedure are performed.

B1) After a good product portion of the glass particulate deposit M is produced, the supply of the siloxane as the raw material for glass to the burner 22 is stopped, while the combustion gas is continuously supplied to the burner 22.

B2) A raw material gas port spanning from the vaporizer 24 to the burner 22 is purged by flowing an inert gas therethrough.

B3) When the supply of the combustion gas has been continued for a certain period of time, the supply of the combustion gas is stopped.

B4) The glass particulate deposit M is removed from the reaction vessel 2.

Like the process A1), in the process B1) described above, the method of stopping the supply of the siloxane to the burner 22 may be either stopping the supply of the liquid siloxane from the MFC 25 to the vaporizer 24, or stopping the supply of the liquid siloxane from the siloxane supply tank 21 to the MFC 25, but it is preferable to stop the supply of the liquid siloxane from the siloxane supply tank 21 to the MFC.

Like the process A1), in the process B1) described above, the supply of the combustion gas to the burner 22 is continued even after the good product portion of the glass particulate deposit M is produced.

Even after the process B1), the glass particulate deposit M is not removed from the reaction vessel 2 and the supply of the combustion gas to the burner 22 is continued. Here, even when the supply of the siloxane to the burner 22 is stopped in the process B1) described above, since there is a remainder of siloxane, the siloxane is discharged from the burner 22.

Like the process A3), the specific method of purging by flowing an inert gas in the process B2) is not particularly limited, but it is preferable to continue the supply of the carrier gas (inert gas) from the carrier gas supply device 31 to the vaporizer 24. Accordingly, it is not necessary to further provide a mechanism for supplying the inert gas that is used for purging, and the carrier gas supply mechanism already provided can be used as it is, so that the apparatus configuration can be simplified.

In the above process B3), the supply of the combustion gas is continued for a certain period of time, and the glass particulate deposit is heated with the flame formed by the combustion gas for a certain period of time while the glass particulate deposit is traversed relative to the burner, and then the supply of the combustion gas is stopped. This certain period of time includes a period of time for the siloxane gas remaining in the raw material port to be completely discharged, and a subsequent period of time for roasting the surface of the deposited glass particulate deposit. As described above, the time when the siloxane gas is completely discharged may be confirmed by the presence or absence of color derived from the combustion of the siloxane gas, or may be maintained for a time sufficient to completely discharge the siloxane gas that can be understood from trial results and the like.

It is preferable that the certain time described above is 3 minutes or more and 1 hour or less. If it is less than 3 minutes, the siloxane gas may not be completely discharged, or it may not be sufficient to blow off the gel-like component or the like adhered to the surface. Flowing for 1 hour is sufficient to completely discharge the siloxane gas and also blow off the gel-like component or the like adhered to the surface, and longer than this leads to the waste of the oxyhydrogen gas used, and also the deterioration of the work efficiency.

In the process B3), it is preferable to adjust the flow rate of the combustion gas and the like such that the temperature of the glass particulate deposit is 700° C. or higher and 1200° C. or lower. If it is 700° C. or higher, the gel-like component adhered to the surface may be blown off. If the temperature is higher than 1200° C., the glass particulate deposit may shrink or sinter, in some cases.

After the process B3) is completed, the process B4) is performed. After that, like the process A described above, it is preferable to continuously purge the raw material gas port spanning from the vaporizer 24 to the burner 22 until the production of the next glass particulate deposit M is newly started. Accordingly, from the stopping of the supply of siloxane until the production of a new glass particulate deposit, it is possible to prevent, from the gas discharge port of the burner 22 to the raw material gas port, the oxygen from flowing back.

In the apparatus used here, the pipe between the vaporizer 24 and the burner 22 may be formed of a material containing a metal.

In the apparatus used here, the burner 22 may be a mechanism that is retreated in the radial direction of the glass particulate deposit M according to the growth of the glass particulate deposit M, and at least a part of the supply pipe 26 between the vaporizer 24 and the MFC 25 may be formed of a flexible material such as fluororesin.

The glass particulate deposit M manufactured by performing the process B instead of the process A is also dehydrated and sintered to make the glass transparent, and the glass base material is obtained, as in the process A. The obtained glass base material achieves high-quality such as very few bubbles.

The disclosure is not limited to these embodiments, but is intended to be indicated by the claims, and includes all modifications within the scope and meaning equivalent to the claims.

### REFERENCE SIGNS LIST

1: deposit producing apparatus

2: reaction vessel

3: lifting and rotating device

5: control unit

10: support rod

11: raw rod

12: discharge pipe

21: siloxane supply device

22: burner

23: liquid siloxane

24: vaporizer

25: mass flow controller (MFC)

26: supply pipe

28: tape heater

30: glass particles

31: carrier gas supply device

32: combustion gas supply device

M: glass particulate deposit

1. A method for producing a glass particulate deposit, in which the method uses siloxane as a raw material for glass and includes discharging the siloxane gasified in a vaporizer and a combustion gas from a burner for combustion and thus forming a glass particulate deposit in a reaction vessel, in which the method comprises:
after a good product portion of the glass particulate deposit is produced, stopping the supply of the siloxane as the raw material for glass to the burner while continuously supplying the combustion gas to the burner;
removing the glass particulate deposit from the reaction vessel;
purging a raw material gas port spanning from the vaporizer to the burner by flowing an inert gas therethrough; and
when a color derived from the combustion of the siloxane gas is not observed any more in the flame of the burner, stopping the supply of the combustion gas.

2. A method for producing a glass particulate deposit, in which the method uses siloxane as a raw material for glass and includes discharging the siloxane gasified in a vaporizer and a combustion gas from a burner for combustion and thus forming a glass particulate deposit in a reaction vessel, in which the method comprises:
after a good product portion of the glass particulate deposit is produced, stopping the supply of the siloxane as the raw material for glass to the burner while continuously supplying the combustion gas to the burner;
purging a raw material gas port spanning from the vaporizer to the burner by flowing an inert gas therethrough; and
heating the glass particulate deposit with the flame formed by the combustion gas for a certain period of time while traversing the glass particulate deposit relative to the burner, and then stopping the supply of the combustion gas.

3. The method for producing a glass particulate deposit according to claim 1, further comprising:
even after the production of the glass particulate deposit, continuously purging the raw material gas port spanning from the vaporizer to the burner until production of a next glass particulate deposit is newly started.

4. The method for producing a glass particulate deposit according to claim 1, further comprising:
when a good product portion of the glass particulate deposit is produced, using a carrier gas that is an inert gas to gasify the siloxane in the vaporizer, performing purging of the raw material gas port by continuously flowing the carrier gas even after the supply of the siloxane gas to the burner is stopped.

5. The method for producing a glass particulate deposit according to claim 1, wherein
nitrogen is used as the inert gas.

6. The method for producing a glass particulate deposit according to claim 1, wherein
a pipe between the vaporizer and the burner is formed of a material containing a metal.

7. The method for producing a glass particulate deposit according to claim 1, wherein
a pipe between the vaporizer and the burner is heated to a temperature equal to or higher than a boiling point of the siloxane.

8. The method for producing a glass particulate deposit according to claim 2, further comprising:
even after the production of the glass particulate deposit, continuously purging the raw material gas port spanning from the vaporizer to the burner until production of a next glass particulate deposit is newly started.

9. The method for producing a glass particulate deposit according to claim 2, further comprising:
when a good product portion of the glass particulate deposit is produced, using a carrier gas that is an inert gas to gasify the siloxane in the vaporizer, performing purging of the raw material gas port by continuously flowing the carrier gas even after the supply of the siloxane gas to the burner is stopped.

10. The method for producing a glass particulate deposit according to claim 2, wherein
nitrogen is used as the inert gas.

11. The method for producing a glass particulate deposit according to claim 2, wherein
a pipe between the vaporizer and the burner is formed of a material containing a metal.

12. The method for producing a glass particulate deposit according to claim 2, wherein
a pipe between the vaporizer and the burner is heated to a temperature equal to or higher than a boiling point of the siloxane.
